(19) United States
(12) Patent Application Publication
(10) Pub. No.: US 2015/0043480 A1
(43) Pub. Date: Feb. 12, 2015

(54) System and Method for Multi-Subframe Data Transmission

(71) Applicant: BROADCOM CORPORATION, Irvine, CA (US)

(72) Inventors: Daewon LEE, Suwanee, GA (US); Sirikiat ARIYAVISITAKUL, Alpharetta, GA (US)

(73) Assignee: BROADCOM CORPORATION, Irvine, CA (US)

(21) Appl. No.: 14/453,339

(22) Filed: Aug. 6, 2014

Related U.S. Application Data
(60) Provisional application No. 61/863,372, filed on Aug. 7, 2013.

(51) Int. Cl. H04L 5/00; H04W 72/04

(52) U.S. Cl. CPC H04L 5/0055; H04W 72/042; H04L 5/0092
USPC 370/329

(57) ABSTRACT

Systems and methods for multi-subframe data transmission are provided. A multi-subframe scheduling (MSS) downlink subframe is transmitted from a base station to a user equipment (UE). The MSS downlink subframe includes a control signal that describes consecutive data transmissions in the MSS downlink subframe and in a plurality of subsequent downlink subframes. The plurality of subsequent downlink subframes include no control information, thereby allowing for control signaling overhead to be reduced.

### CROSS-REFERENCE TO RELATED APPLICATION(S)

The present application claims the benefit of U.S. Provisional Application No. 61/863,372, filed on Aug. 7, 2013, which is incorporated herein by reference in its entirety.

### TECHNICAL FIELD

The present disclosure relates generally to multi-subframe data transmission.

### BACKGROUND

### Background Art

In the Long Term Evolution (LTE) standard, a control signal in the Physical Downlink Control Channel (PDCCH) needs to be transmitted along with the data signal in the Physical Downlink Shared Channel (PDSCH) in every downlink subframe transmitted from a base station to a User Equipment (UE). However, with cellular networks becoming denser and data throughput requirements continuing to increase, there is a greater demand for improved radio resource efficiency by reducing control signaling from the base station.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an example environment in which embodiments can be practiced or implemented.

FIG. 2 is an example that illustrates a downlink subframe transmission and an associated uplink acknowledgement/no-acknowledgment (ACK/NACK) response.

FIG. 3 is an example that illustrates an uplink subframe transmission and an associated downlink ACK/NACK response.

FIG. 4 is an example that illustrates resource allocation for a downlink ACK/NACK response.

FIG. 5 is an example that illustrates downlink control signaling.

FIG. 6 is an example that illustrates resource allocation for uplink ACK/NACK responses.

FIG. 7 is an example that illustrates ACK/NACK response for Semi-Persistent Scheduling (SPS).

FIG. 8 is an example that illustrates a multi-subframe scheduling approach according to an embodiment.

FIG. 9 is an example that illustrates an ACK/NACK response approach for multi-subframe scheduling according to an embodiment.

FIG. 10 is an example that illustrates the location of a Control Channel Element (CCE) search space for a User Equipment (UE) across consecutive multi-subframe scheduled subframes.

FIG. 11 is an example that illustrates resource allocation for an ACK/NACK response from the UE in response to the consecutive subframes shown in FIG. 10.

FIG. 12 is an example that illustrates the location of a user-specific CCE search space for a UE across consecutive multi-subframe scheduled subframes.

FIG. 13 is an example that illustrates resource allocation for ACK/NACK responses from the first and second UEs in response to the consecutive subframes shown in FIG. 12.

FIG. 14 is an example that illustrates the location of a user-specific CCE search space for a UE across consecutive multi-subframe scheduled subframes.

FIG. 15 is an example that illustrates resource allocation for an ACK/NACK response from the UE in response to the consecutive subframes shown in FIG. 14.

FIG. 16 is an example that illustrates the location of user-specific CCE search spaces across consecutive subframes for two UEs.

FIG. 17 is an example that illustrates resource allocation for an ACK/NACK response from one of the two UEs in response to the consecutive subframes shown in FIG. 16.

FIG. 18 is an example that illustrates resource allocation for an ACK/NACK response from a UE in response to multi-subframe scheduling.

FIG. 19 illustrates an example communication device according to an embodiment.

FIG. 20 is an example process according to an embodiment.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

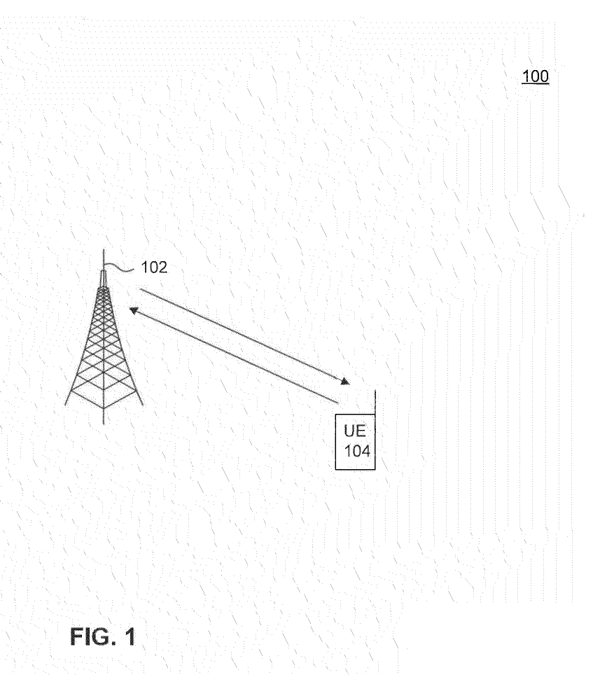

FIG. 1 illustrates an example environment 100 in which embodiments can be practiced or implemented. Example environment 100 is provided for the purpose of illustration only and is not limiting of embodiments. As shown in FIG. 1, example environment 100 includes, without limitation, a base station 102 and a User Equipment (UE) 104. Base station 102 and UE 104 can be in communication with each other over a downlink channel (from base station 102 to UE 104) and an uplink channel (from UE 104 to base station 102).

Base station 102 can be a cellular network base station, such as an LTE Evolved Node B (eNB) or a WCDMA Node B, for example. Alternatively, base station 102 can be a wireless network access point (AP), such as a WLAN or a Bluetooth AP, for example. UE 104 can be a cellular mobile terminal or a WLAN or Bluetooth device, for example.

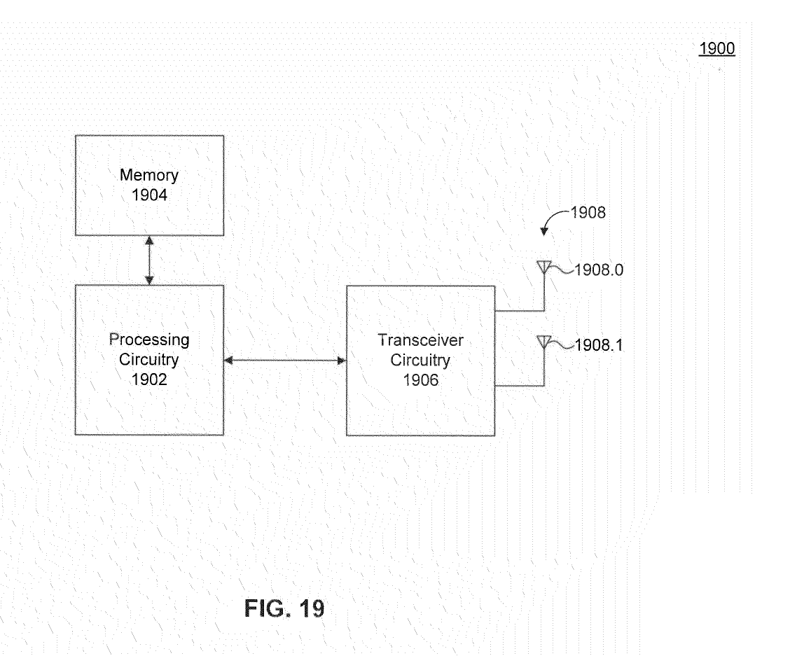

In an embodiment, base station 102 or UE 104 can each be implemented as illustrated by example communication device 1900 shown in FIG. 19. Example communication device 1900 is provided for the purpose of illustration only and is not limiting of embodiments. As shown in FIG. 19, example communication device 1900 includes a processor circuitry 1902, a memory 1904, transceiver circuitry 1906, and an antenna array 1908 including a plurality of antenna elements 1908.0 and 1908.1. Processor circuitry 1902 can be implemented as described herein and can be configured to perform the base station or UE functionalities described herein. In an embodiment, processor circuitry 1902 executes logic instructions stored in memory 1904 to perform the functionalities described herein. Transceiver circuitry 1906 includes digital and/or analog circuitry that perform transmit and receive radio frequency (RF) processing, including filtering, power amplification, frequency up-conversion, frequency down-conversion, etc. Together with antenna array 1908, transceiver circuitry 1906 enables transmitting and receiving wireless signals by communication device 1900. In an embodiment, transceiver circuitry 1906 and/or antenna array 1908 can be controlled by processor circuitry 1902 to transmit/receive at specified time-frequency resources (e.g., physical resource elements).

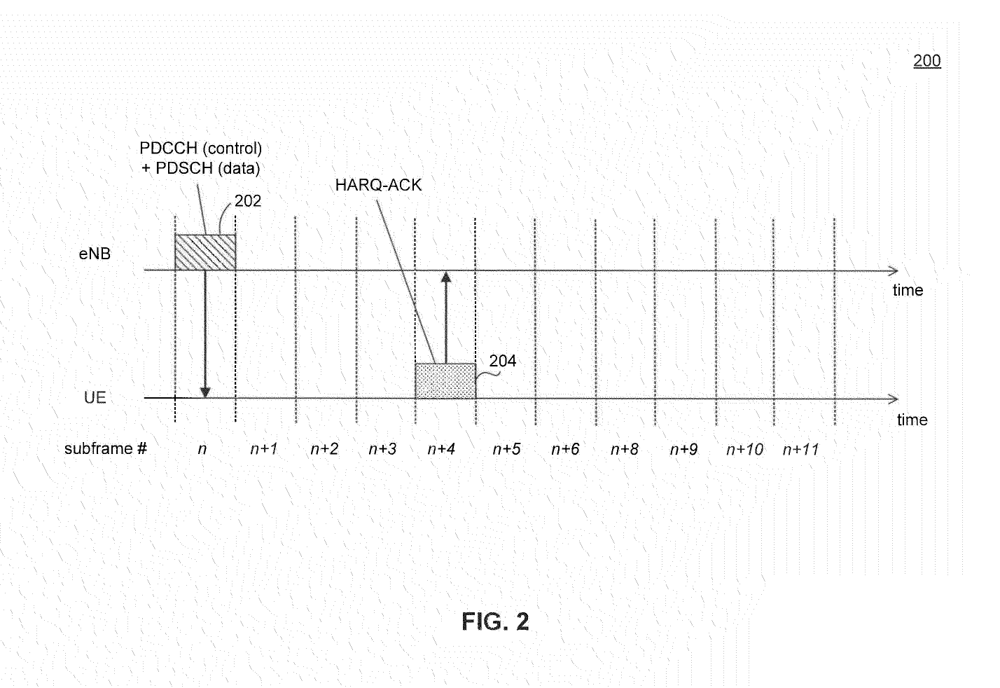

FIG. 2 is an example 200 that illustrates a downlink subframe transmission and an associated uplink acknowledgement/no-acknowledgment (ACK/NACK) response. As shown in FIG. 2, downlink subframe 202 is transmitted from an eNB to a UE at a time indexed by n. In LTE, downlink subframe 202 includes a data signal and a control signal that contains information necessary for the UE to receive and decode the data signal. The data signal is carried by resource elements associated with the Physical Downlink Shared Channel (PDSCH). The control signal is carried by resource elements associated with the Physical Downlink Control Channel (PDCCH).

The UE uses a hybrid automatic request (HARQ) protocol that transmits an ACK/NACK response k subframes after the reception of a data signal. In example 200, the UE sends an ACK/NACK response in an uplink subframe 204 4 subframes (typically, k=4 for Frequency Division Duplex (FDD) mode but can vary for Time Division Duplex (TDD) mode) after the reception of the data signal in downlink subframe 202. The ACK/NACK response is carried by resource elements associated with the Physical Uplink Control Channel (PUCCH) of uplink subframe 204.

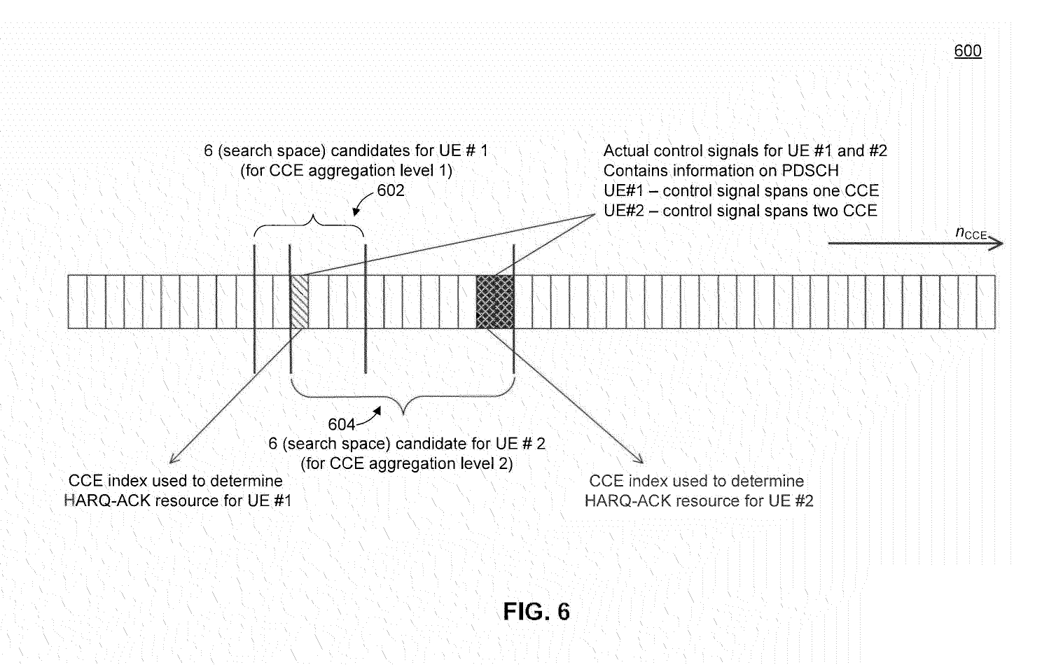

It is noted that uplink subframe 204 may carry ACK/NACK responses from multiple UEs. A PUCCH resource element for a UE within uplink subframe 204 is defined by a PUCCH resource index, n_{PUCCH}^{(x,p)}, where x represents a signal format index (either 1, 2, or 3) of the PUCCH and p represents an index of an antenna port (either 1 or 2) transmitting the PUCCH signal. To insure the resources used for ACK/NACK responses from multiple UES are orthogonal in a uplink subframe 204, the PUCCH resource index for the UE is determined based or the location of the control signal transmitted to the UE in the PDCCH. This is further described below with reference to FIG. 6.

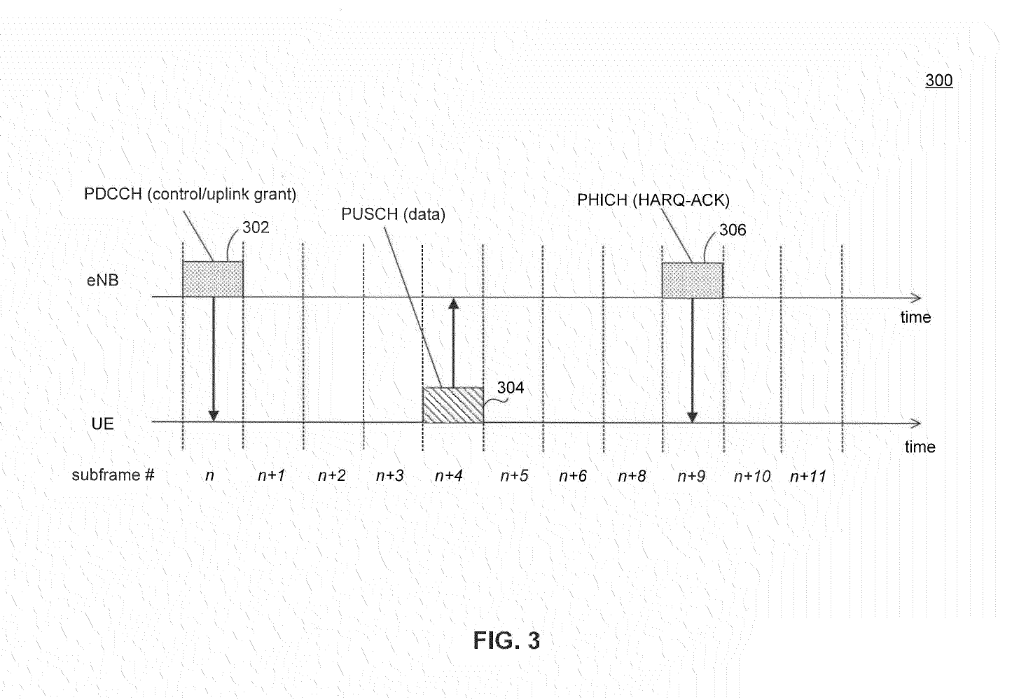

FIG. 3 is an example 300 that illustrates an uplink subframe transmission and an associated downlink ACK/NACK response. As shown in FIG. 3, for uplink transmission, the eNB first transmits an uplink grant to the UE in a downlink subframe 302. The uplink grant contains control information necessary for the UE to transmit on the Physical Uplink Shared Channel (PUSCH). Specifically, the uplink grant specifies the resource elements of the PUSCH to be used by the UE.

k′ subframes after reception of the uplink grant, the UE transmits a data signal on the PUSCH resource elements of an uplink subframe 304 to the base station. k″ subframes after reception of the data signal, the eNB responds to the UE by transmitting an ACK/NACK response on resource elements associated with the Physical HARQ Indicator Channel (PHICH) of a downlink subframe 306. Typically, in FDD-based systems, k′=k″=4.

Downlink subframe 306 can carry ACK/NACK responses for multiple UEs. A PHICH resource element for a UE is defined by two parameters, a PHICH group index, n_{PHICH}^{group}, and an orthogonal sequence index, n_{PHICH}^{seq}. This ensures that ACK/NACK response resources used for the multiple UEs are orthogonal to each other within downlink subframe 306.

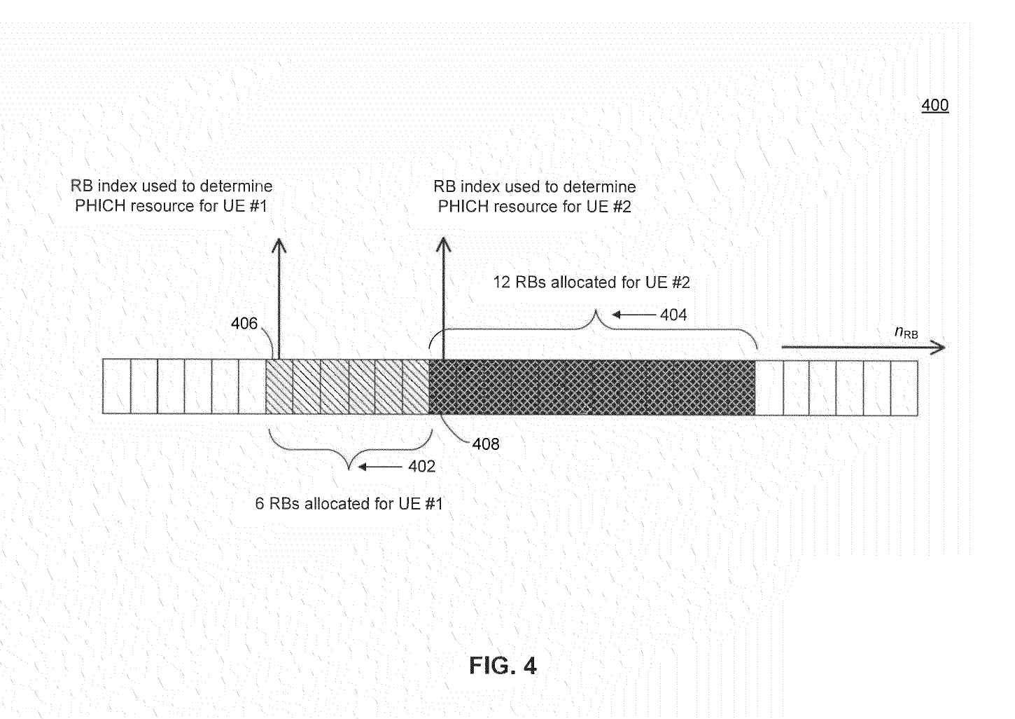

A resource index for a PHICH resource element for a UE is derived directly from an index of a first resource block (RB) used by the UE's uplink transmission and an index of a reference signal (RS) sequence. If spatial division multiplexing (SDMA) is not used in the uplink, only one UE can occupy a particular RB, and thus no two PHICH resource elements can have the same resource index. Otherwise, if SDMA is used, the combination of the first RB index and the RS sequence index can resolve PHICH resource collisions among UEs. FIG. 4 is an example 400 that illustrates PHICH resource determination for two UEs. In example 400, UE #1 is allocated an uplink transmission window 402 consisting of 6 RBs. UE #2 is allocated an uplink transmission window 404 consisting of 12 RBs. Note that windows 402 and 404 are defined logically so the RBs contained therein may or may be consecutive in time and/or frequency. As shown, the index of the PHICH resource element for UE #1 is derived from the index of the first RB 406 of window 402. Similarly, the index of the PHICH resource element for UE #2 is derived from the index of the first RB 408 of window 408.

As mentioned above, the control signal contained in the PDCCH transmitted to a UE provide all the necessary information for the UE to decode the PDSCH. In addition, the control signal includes information for the UE to encode PUCCH transmissions to the base station. Typically, a UE does not have prior knowledge of the location of its control signal within the PDCCH (or the location of the Control Channel Elements (CCEs) of the PDCCH carrying its control signal). As such, the UE must blindly decode and detect its control signal within the PDCCH.

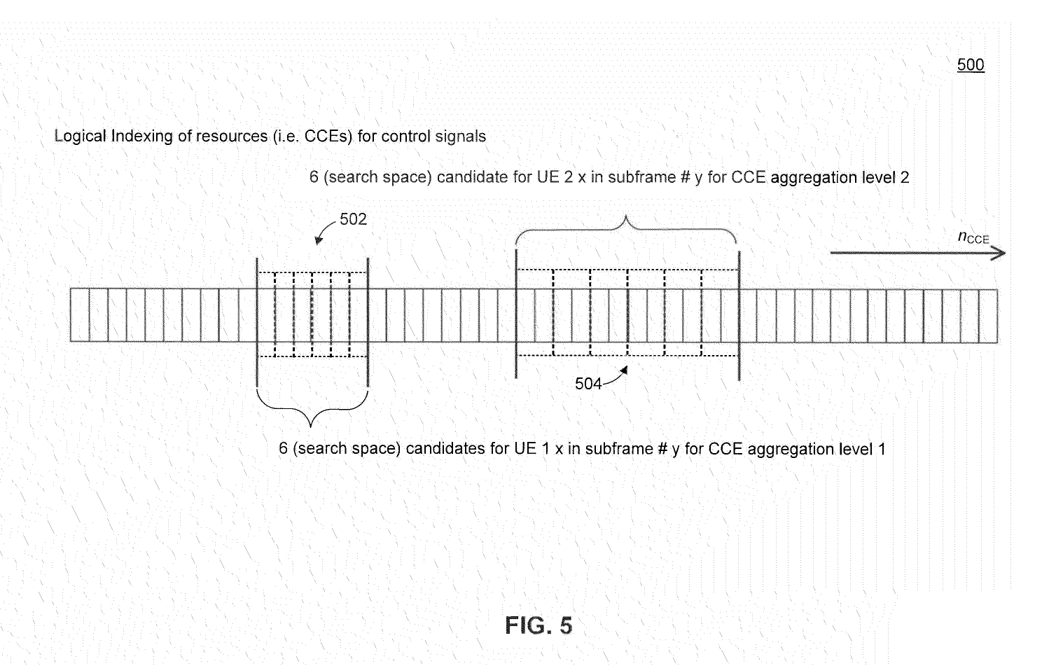

To facilitate the UE's detection of its control signal on the PDCCH, the LTE specifications narrows the PDCCH search space for the UE by providing it with a control information search space (SS) for each downlink subframe. The control information search space defines a set of SS candidates within which the UE should search and detect its control signal. The number of CCEs in a control information search space can vary from one UE to another within the same subframe depending on a CCE aggregation level used for the control information search space. The CCE aggregation level defines the size in CCEs of a SS candidate (which can be equal to 1, 2, 4, or 8) and determines the number of consecutive CCEs used to carry a single control signal information. FIG. 5 is an example 500 that illustrates two search spaces 502 and 504 provided to two different UEs in a given subframe. Search space 502 includes 6 CCEs and defines 6 SS candidates for a CCE aggregation level equal to 1. Search space 504 includes 12 CCEs and defines 6 SS candidates for a CCE aggregation level equal to 2.

As mentioned above, the PUCCH resource index for a UE (which indicates the resource location within the PUCCH of an uplink ACK/NACK from the UE in response to a downlink subframe) is determined based on the location of the control signal transmitted to the UE in the PDCCH. FIG. 6 is an example 600 that illustrates resource allocation for uplink ACK/NACK responses from two different UEs in response to a downlink subframe.

In example 600, UE #1 is provided a search space 602 that includes 6 CCEs and that defines 6 SS candidates for a CCE aggregation level equal to 1. UE #2 is provided a search space 604 that includes 12 CCEs and that defines 6 SS candidates for a CCE aggregation level equal to 2. As shown, the control signal for UE #1 is carried by the third SS candidate of search space 602, which also corresponds to the third CCE of search space 602. The control signal for UE #2 is carried by the last (sixth) SS candidate of search space 604, which corresponds to the 11^{th} and 12^{th} CCEs of search space 604. As such, the PUCCH resource index for UE #1 is derived from the index of the third CCE of search space 602, and the PUCCH resource index for UE #2 is derived from the index of the 11^{th} CCE of search space 604.

Since the control signals for UE #1 and UE #2 are orthogonal (i.e., occupy different CCEs) in the PDCCH, the resulting PUCCH resource indices are also guaranteed to be orthogonal in the PUCCH. Typically, to ensure orthogonality between control signals for different UEs, the network operates to reduce overlap between the control information search spaces of different UEs by randomizing the location of the control information search space of given a UE across subframes. As such, the UE's control information search space can vary from one subframe to another.

As described thus far, in LTE, a control signal in the PDCCH needs to be transmitted along with the data signal in the PDSCH in every downlink subframe transmitted to a UE. The control signal is necessary for the UE to decode the data signal, encode any uplink data transmissions, and determine the resource index for transmitting an ACK/NACK response to the base station. However, with cellular networks becoming denser and data throughput requirements continuing to increase, there is a greater demand for improved radio resource efficiency. Specifically, as further described below, the control signaling overhead from the base station can be reduced by using a multi-subframe scheduling approach, where a single control signal in a downlink subframe can provide the necessary control information for multiple downlink subframes and/or associated ACK/NACK responses.

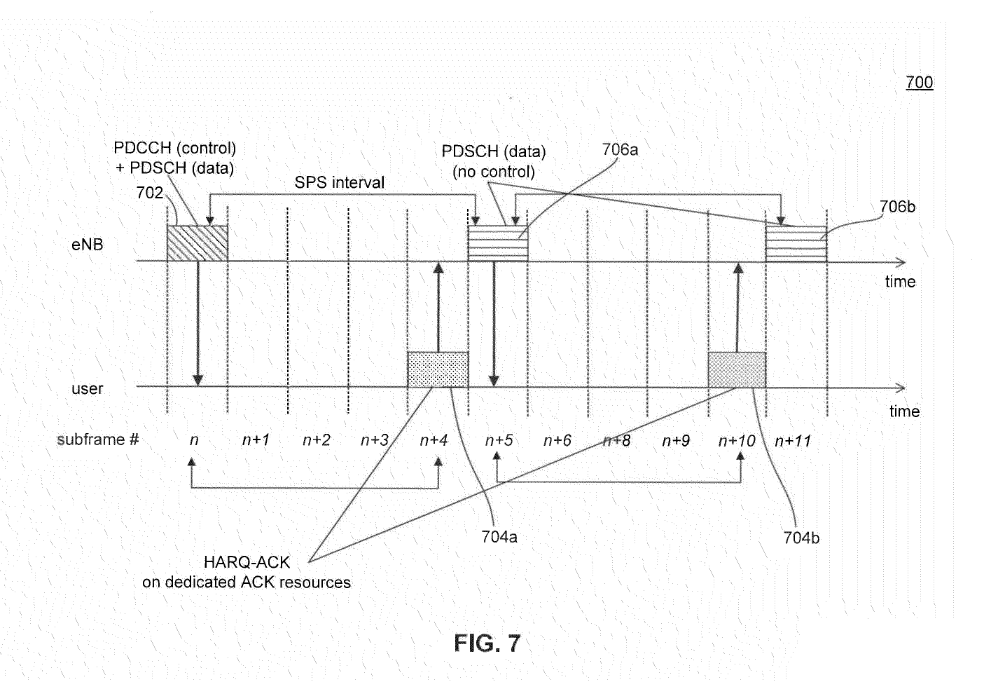

One example of multi-subframe scheduling is Semi-Persistent Scheduling (SPS) currently defined in LTE, illustrated in example 700 of FIG. 7. A first downlink subframe 702, including both control and data, initiates SPS by informing the UE of an SPS interval between periodic SPS downlink data transmissions and a dedicated PUCCH resource for sending ACK/NACK responses. Subsequent downlink subframes 706a, 706b, etc., which occur periodically according to the SPS interval until de-activated by other control signaling from the base station, carry data only to the UE. Uplink HARQ ACK/NACK responses to the SPS transmissions are carried by uplink subframes 704a, 704b, etc., which occur at fixed periods (e.g., 4 subframes) after their corresponding downlink subframes 706a, 706b, etc. The ACK/NACK responses occupy the same dedicated PUCCH resource within their respective uplink subframes. Thus, unlike in regular data transmissions, the UE does not need to determine the PUCCH resource index from the index of the first CCE that carries control signaling to the UE.

SPS is designed for data traffic with regular interval traffic patterns, such as voice over internet protocol (VOIP), for example, but is inefficient for traffic with bursty or irregular traffic patterns, because the SPS interval cannot be configured dynamically. In addition, when SPS is used by a large number of UEs, the base station must reserve at least one PUCCH resource for each SPS transmission in addition to PUCCH resources for regular (dynamic) scheduling. This results in a large uplink overhead and a loss in uplink throughput. A dynamically configurable multi-subframe scheduling approach that can accommodate bursty and irregular traffic patterns is described below. This approach can complement SPS to better support various data traffic types.

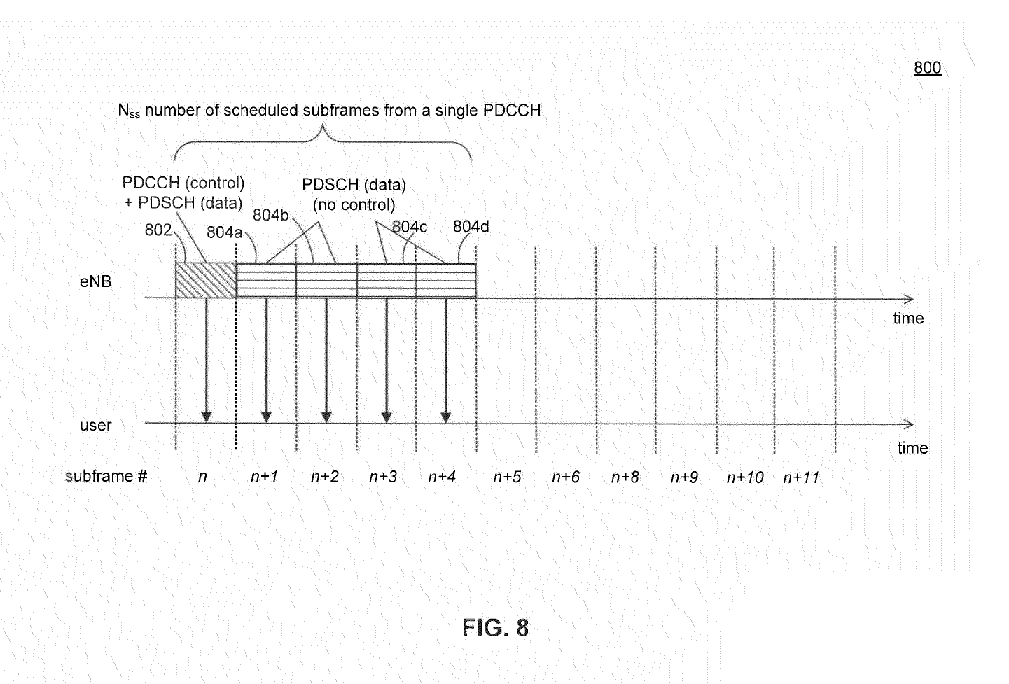

FIG. 8 is an example 800 that illustrates a multi-subframe scheduling approach according to an embodiment. Example 800 is provided for the purpose of illustration only and is not limiting of embodiments. As shown in FIG. 8, a first downlink subframe 802, including both a data signal and a control signal, schedules N_{SS} consecutive data transmissions, including the data transmission in first downlink subframe 802 and the data transmissions in subsequent downlink subframes 804a, 804b, 804c, and 804d. In an embodiment, the control signal indicates the number N_{SS} of consecutive data transmissions, and identifies a set of resource blocks (within the downlink subframe) and a modulation and coding scheme (MCS) used for all the data transmissions.

In another embodiment, the control signal identifies a starting data symbol index for identifying a starting data symbol within each of the subsequent downlink subframes 804a, 804b, 804c, and 804d. This is because the number of symbols used for PDCCH may be different between first downlink subframe 802 and subsequent downlink subframes 804a, 804b, 804c, and 804d, resulting in data starting at a different position within subsequent downlink subframes 804a, 804b, 804c, and 804d than in first downlink subframe 802. In an embodiment, the starting data symbol index can be the same for all subsequent downlink subframes 804a, 804b, 804c, and 804d to reduce control signaling overhead in first downlink subframe 802.

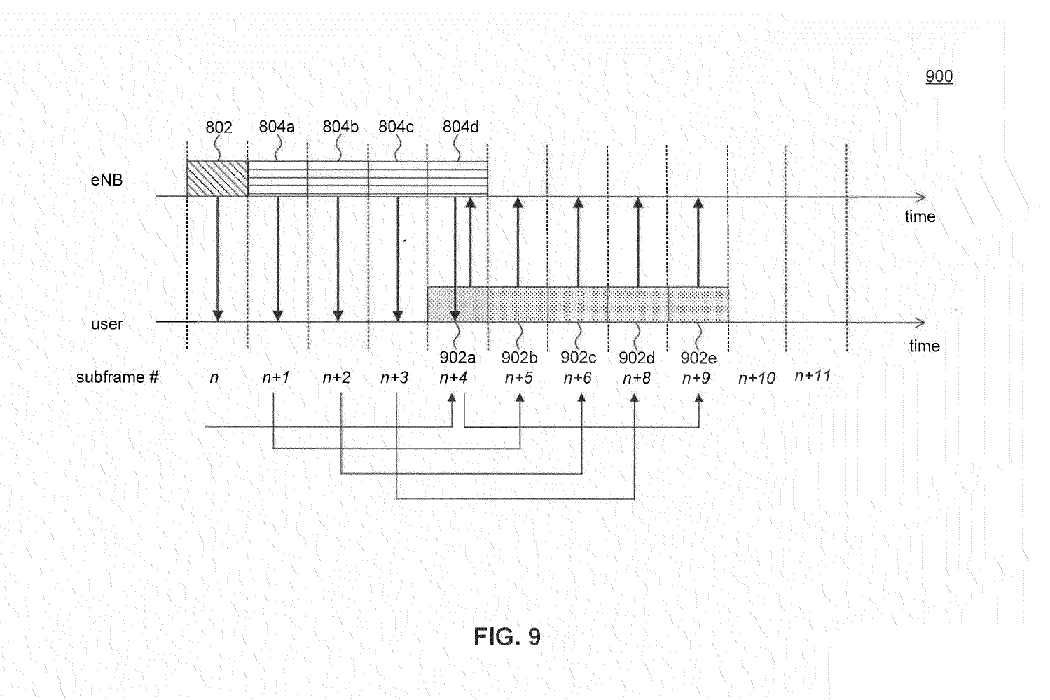

FIG. 9 is an example 900 that illustrates an ACK/NACK response approach for multi-subframe scheduling according to an embodiment. Example 900 is provided for the purpose of illustration only and is not limiting of embodiments. In this approach, the UE transmits an ACK/NACK response for each individual downlink subframe in a corresponding uplink subframe that occurs at a fixed interval (e.g., 4 subframes) after reception of the individual downlink subframe. For example, as shown in FIG. 9, in response to downlink subframes 802 and 804a-d described above, the UE sends ACK/NACK responses in consecutive uplink subframes 902a, 902b, 902c, 902d, and 902e.

The PUCCH resource index for the ACK/NACK response to first downlink subframe 802 is determined as described above based on the index of the first CCE in first downlink subframe 802. PUCCH resources for subsequent ACK/NACK responses can be determined as further described below.

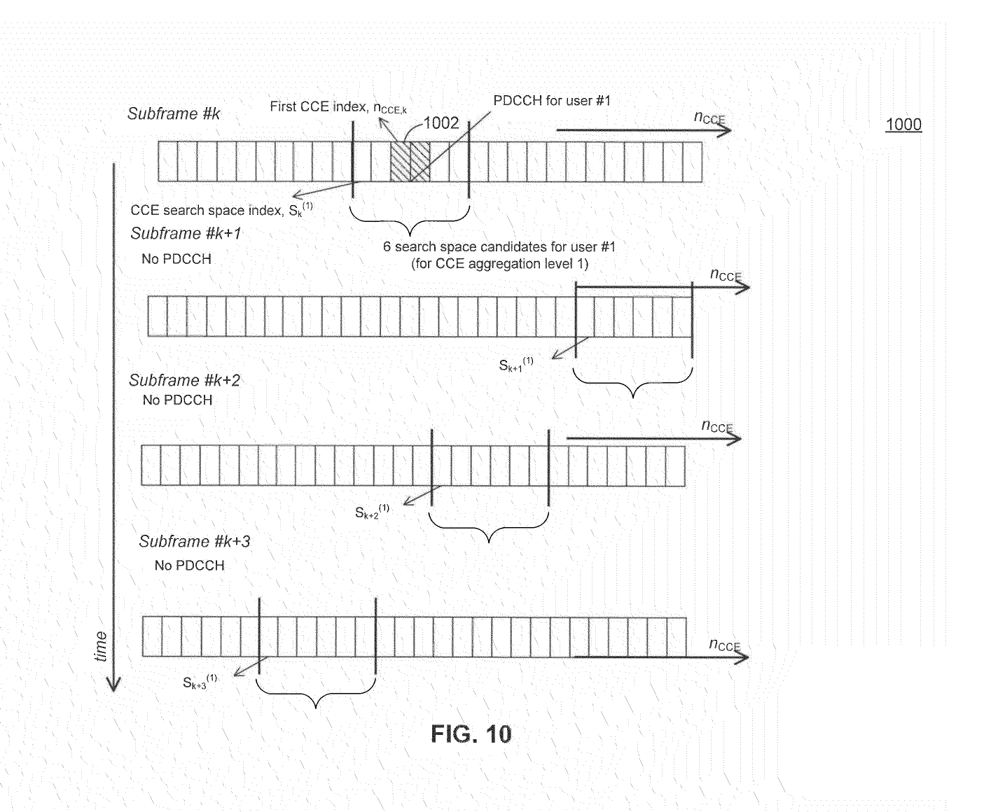

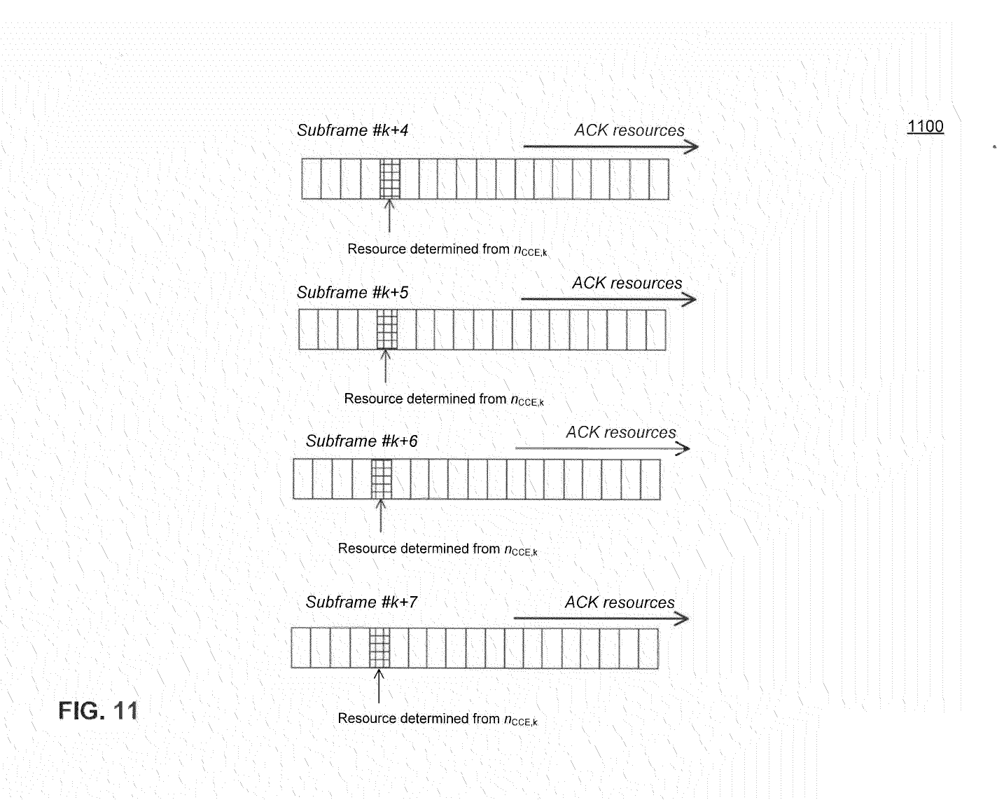

In an embodiment, as illustrated in FIGS. 10 and 11, the index of the first CCE derived from first downlink subframe 802 is used to determine the PUCCH resources for each of the subsequent ACK/NACK responses. FIG. 10 is an example 1000 that illustrates the location of the user-specific CCE search space for a UE (within a logical indexing of CCEs present in a downlink subframe) for consecutive Multi-subframe scheduled downlink subframes. Example 1000 assumes that multi-subframe scheduling begins in subframe k for subframes k to k+3. As Shown, the user-specific CCE search space for the UE is randomized in location within the logical indexing of CCEs in the downlink subframe. However, only the user-specific CCE search space of subframe k contains control information, beginning with first CCE, 1002.

According to this embodiment, the index of first CCE 1002 is used to derive the PUCCH resource indices for every ACK/NACK response to the multi-subframe scheduled downlink subframes. As a result, as shown in example 1100 of FIG. 11, the ACK/NACK responses use the same PUCCH resource within available PUCCH resources across all of uplink subframes k+4, k+5, k+6, and k+7, which correspond respectively to downlink subframes k, k+1, k+2, and k+3.

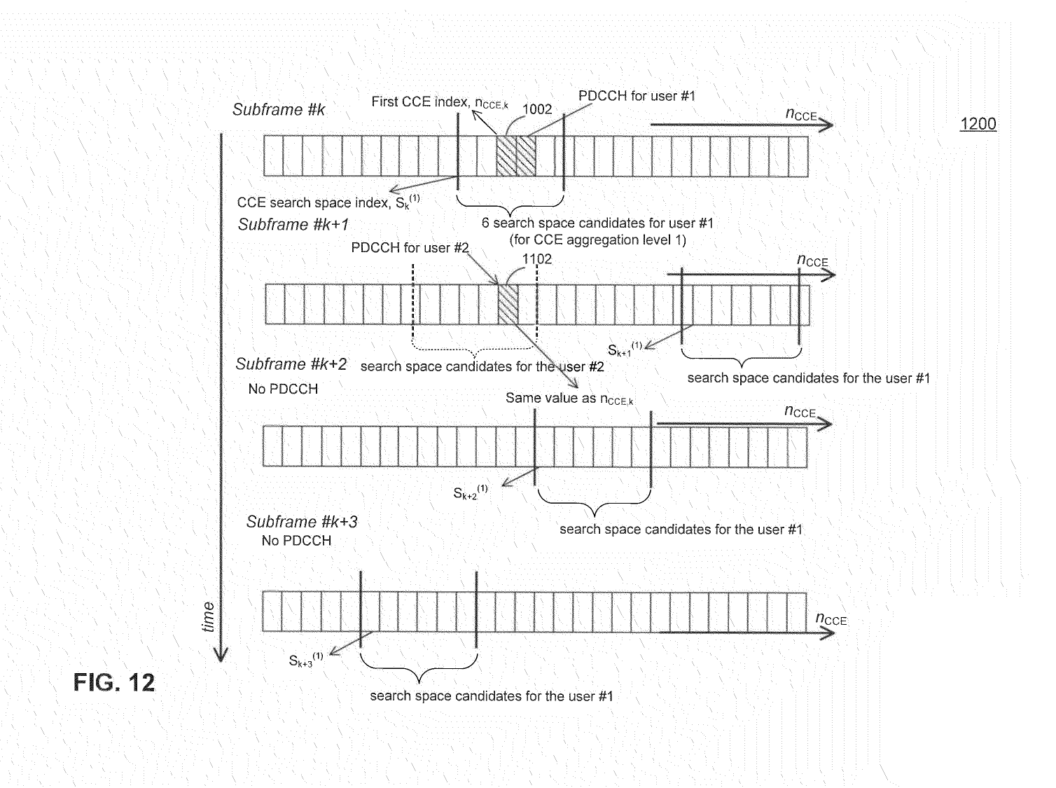

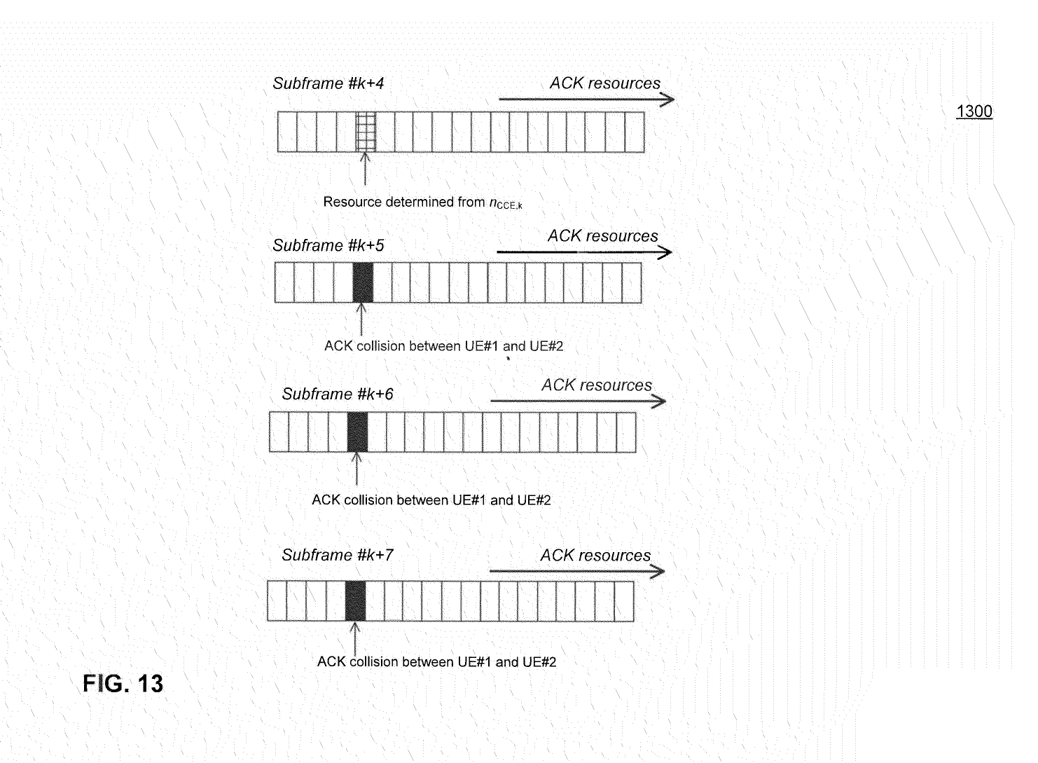

A drawback of this approach is that the PUCCH resource derived from the index of first CCE 1002 becomes reserved for the UE for the duration of the multi-subframe scheduled downlink subframes. If, as illustrated in examples 1200 and 1300 of FIGS. 12 and 13, the first CCE 1202 of another UE scheduled for simultaneous multi-subframe transmission (e.g., beginning in downlink subframe k+1, k+2, or k+3) falls in the same location as first CCE 1002, then ACK/NACK responses of the two UEs will collide with each other as shown in FIG. 13.

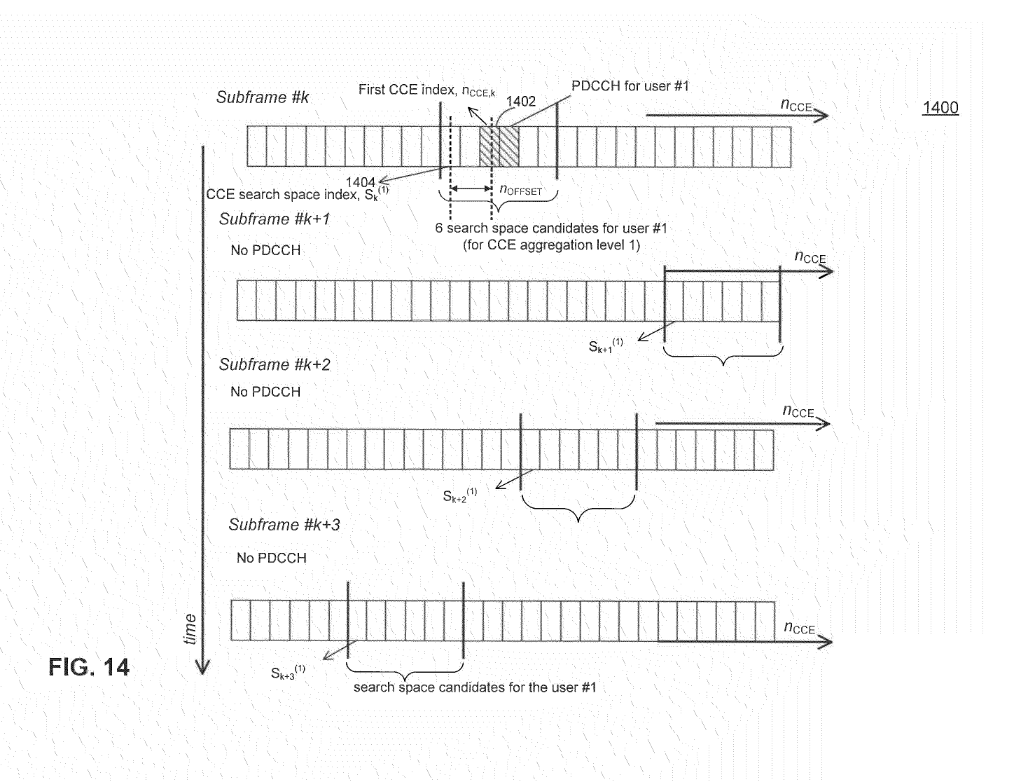

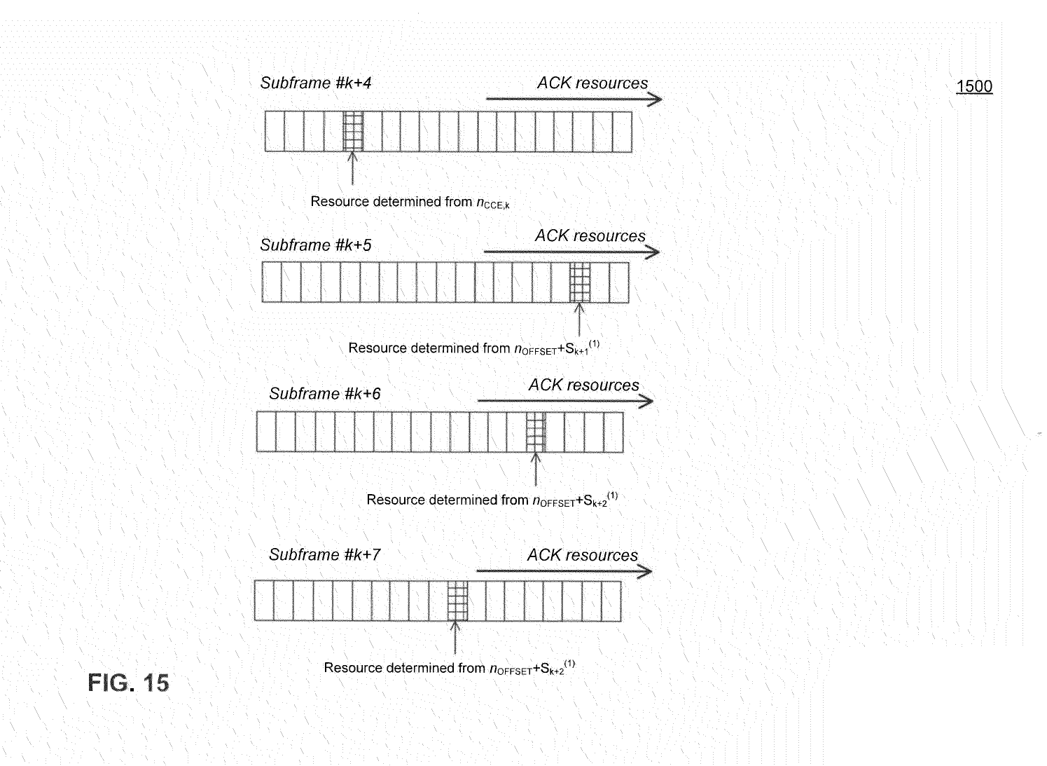

To avoid ACK/NACK response collisions, in another embodiment illustrated in FIGS. 14 and 15, the PUCCH resources used for the subsequent ACK/NACK responses are randomized across uplink subframes. In an embodiment, the PUCCH resource for an ACK/NACK response of the subsequent ACK/NACK responses is determined as a function of the start location of the control information search space of the corresponding downlink subframe (the downlink subframe for which the ACK/NACK response is being transmitted). Since the control information search space for a UE is randomized across downlink subframes, the resulting PUCCH resources for the subsequent ACK/NACK responses will also be randomized, resulting in lower collisions between UEs.

In an embodiment, a CCE offset is defined as the difference between the index of the first CCE of the PDCCH (the first CCE carrying control information in the user-specific CCE search space) and the index of the first CCE of the user-specific CCE search space in the first downlink subframe. For example, as shown in example 1400 of FIG. 14, the CCE offset is the difference between the index of a first CCE 1402 of the PDCCH and the index of a first CCE 1404 of the user-specific CCE search space corresponding to subframe k. The PUCCH resource for an ACK/NACK response of the subsequent ACK/NACK responses is then determined as a function of the sum of the CCE offset and the index of the first CCE of the user-specific CCE search space of the corresponding subsequent downlink subframes. For example, as shown in example 1500 of FIG. 15, the location within uplink subframe k+5 of the PUCCH resource corresponding to downlink subframe k+1 is determined based on the sum of the CCE offset (n_{OFFSET}) and the index (Sₖ₊₁⁽¹⁾) of the first CCE of the user-specific CCE search space corresponding to downlink subframe k+1.

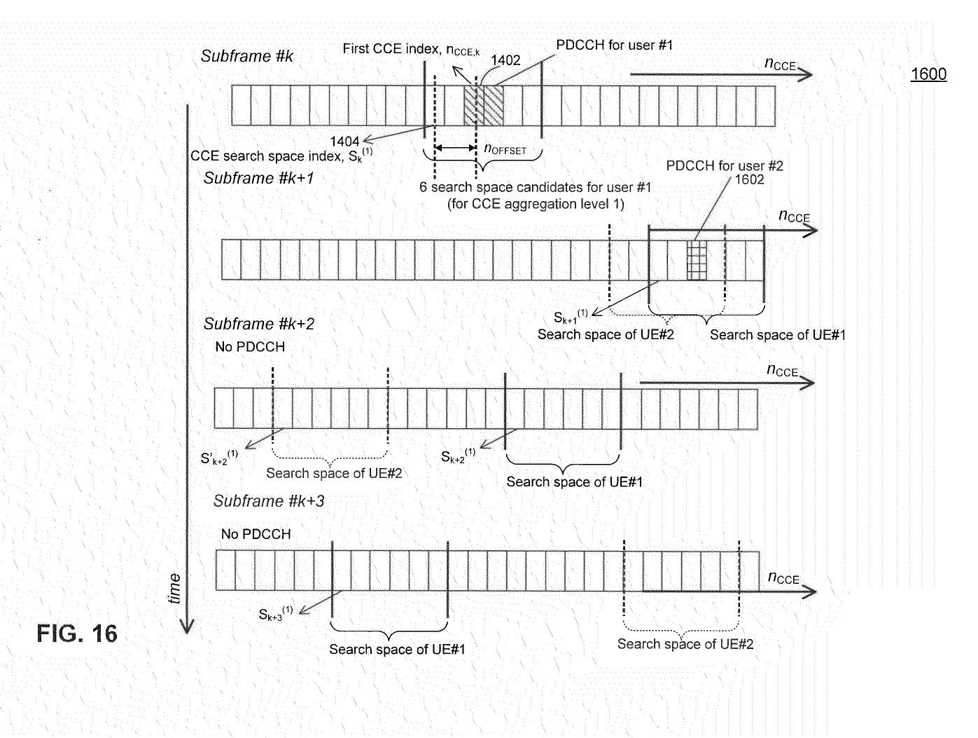

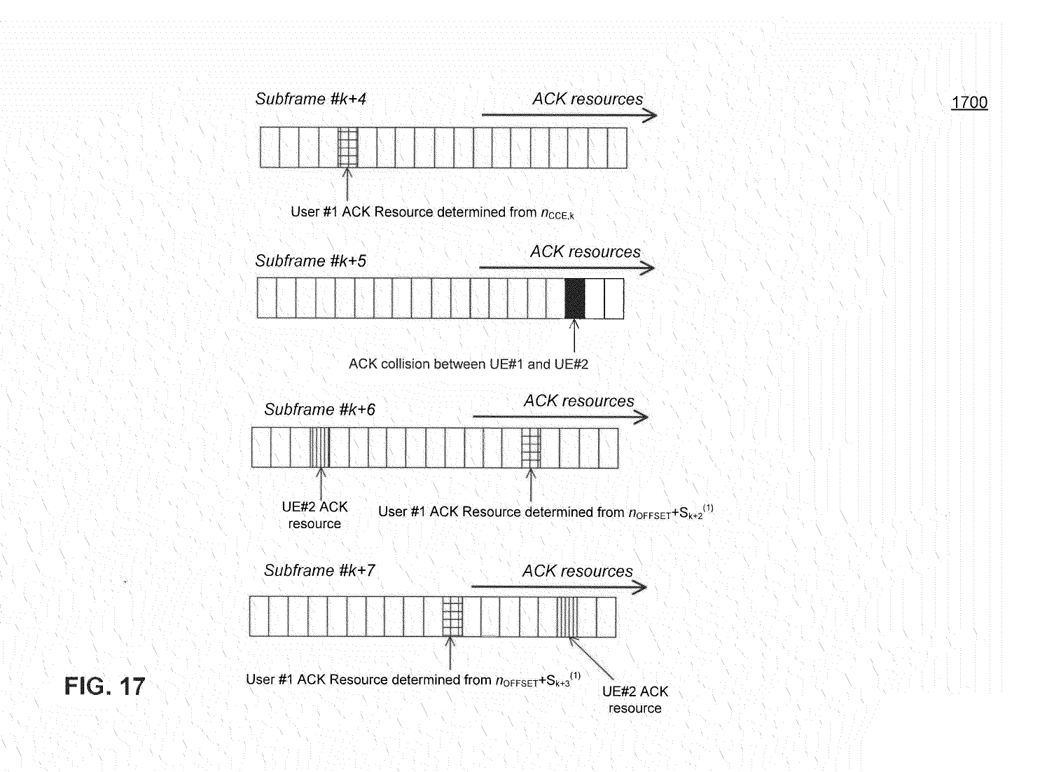

Using this scheme, ACK/NACK response collision probability can be reduced significantly, with collisions occurring only if the sum of the CCE offset and the index of the first CCE of the user-specific CCE search space for a downlink subframe correspond to the index of the first CCE of the PDCCH of another UE. For example, as shown in example 1600 of FIG. 16, for subframe k+1, the sum of the CCE offset (n_{OFFSET}) and the index Sₖ₊₁⁽¹⁾ corresponding to the first CCE of the user-specific CCE search space of UE #1 is equal to the index of first CCE 1602 of the PDCCH of UE #2. As a result, an ACK/NACK response collision occurs in uplink subframe k+5. However, the collision between the two UEs is not likely to occur more than once as shown in example 1700 of FIG. 17.

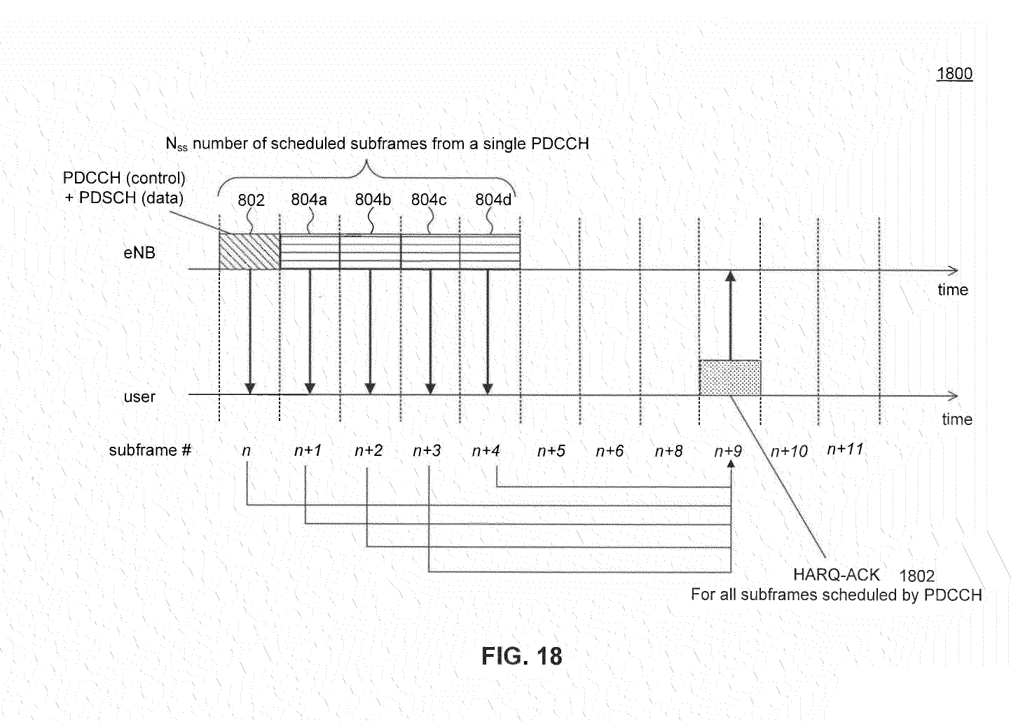

FIG. 18 is an example 1800 that illustrates another ACK/NACK response approach for multi-subframe scheduling according to an embodiment. Example 1800 is provided for the purpose of illustration only and is not limiting of embodiments. In this approach, the UE transmits a single ACK/NACK response for all of multi-subframe scheduled downlink subframes. For example, as shown in FIG. 18, the UE sends a single ACK/NACK response 1802 in response to all of downlink subframes 802, 804a, 804b, 804c, and 804d. In an embodiment, ACK/NACK response 1802 is transmitted a fixed number of subframes (e.g., 4 subframes) after reception of the last downlink subframe 804d. In an embodiment, if all the data transmissions in all of downlink subframes 802 and 804a-d have been successfully received and decoded by the UE, then the UE transmit an ACK in response 1802. Otherwise, if any of the data transmissions cannot be successfully decoded, the UE sends a NACK in response 1802. The PUCCH resource for ACK/NACK response 1802 can be determined using the same approaches described above. In an embodiment, the PUCCH resource index is determined from the index of the first CCE of the PDCCH in downlink subframe 802. In another embodiment, the PUCCH resource is determined based on a sum of a CCE offset (determined from first downlink subframe 802 as discussed above) and the index of the first CCE of the user-specific CCE search space corresponding to the last downlink subframe 804d.

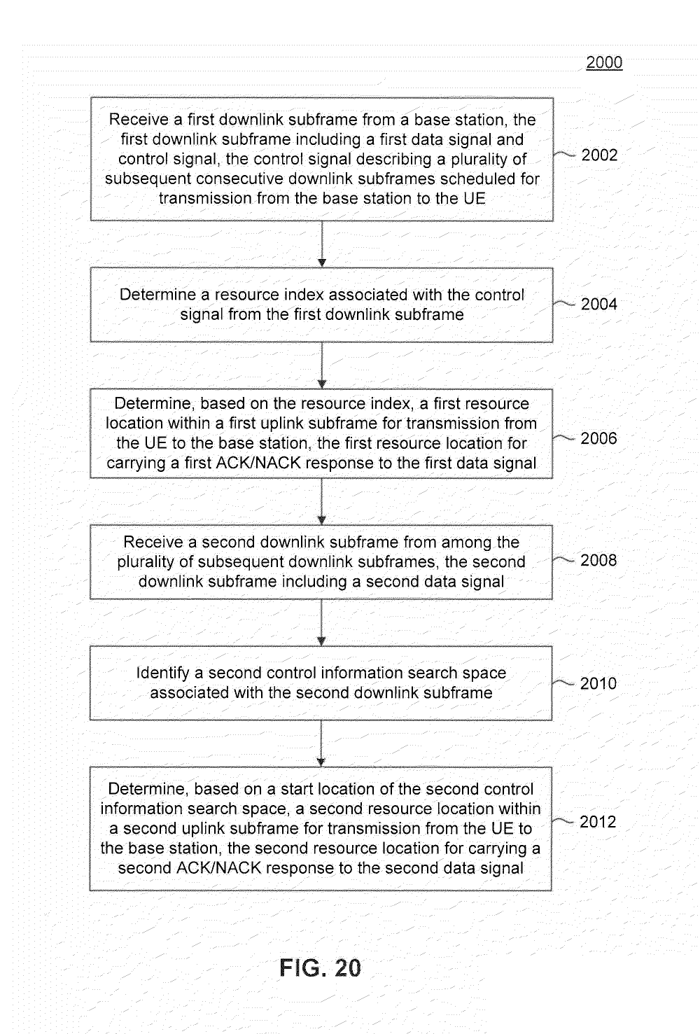

FIG. 20 is an example process 2000 according to an embodiment. Example process 2000 is provided for the purpose of illustration only and is not limiting of embodiments. Example process 2000 can be performed by a UE, such as UE 104, for example, to support multi-subframe scheduling according to an embodiment.

As shown in FIG. 20, example process 2000 begins in step 2002, which includes receiving a first downlink subframe from a base station. In an embodiment, the first downlink subframe includes a first data signal and a control signal, and the control signal describes a plurality of subsequent consecutive downlink subframes scheduled for transmission from the base station to the UE. In an embodiment, the first downlink subframe and the plurality of subsequent downlink subframes are consecutive. For example, the first downlink subframe may correspond to a subframe such as subframe 802 and the plurality of subsequent downlink subframes may correspond to subframes such as subframes 804a-d in example 800 of FIG. 8. In an embodiment, the plurality of subsequent downlink subframes include data only (no control information).

In an embodiment, the control signal includes a number of the plurality of subsequent downlink subframes and describes the data transmissions in the first downlink subframe and the plurality of subsequent downlink subframes. For example, the control signal may identify the set of resources within each of the first downlink subframe and the plurality of subsequent downlink subframes that are carrying the data transmissions. In addition, the control signal may indicate a modulation and coding scheme (MCS) used for the data transmissions. In another embodiment, the control signal can indicate, for each of the plurality of subsequent downlink subframes, a starting data symbol index for identifying a starting data symbol within the downlink subframe.

Subsequently, process 2000 proceeds to step 2004, which includes determining a resource index associated with the control signal from the first downlink subframe. In an embodiment, the resource index corresponds to an index of a first control channel element (CCE) of the control signal. The first CCE corresponds to the first control resource element (e.g., of the PDCCH) within the first downlink subframe that is carrying the control signal. It is noted that the first CCE is “first” in terms of a logical indexing of CCEs available within the first downlink subframe (the first CCE may not necessarily be first in time or frequency among available CCEs).

Next, in step 2006, process 2000 includes determining based on the resource index, a first resource location within a first uplink subframe for transmission from the UE to the base station. In an embodiment, the first resource location is reserved for a first ACK/NACK response to the first data signal contained in the first downlink subframe. In an embodiment, the first resource location corresponds to a PUCCH resource element of the first uplink subframe.

In an embodiment, process 2000 may then include inserting the first ACK/NACK response at the first resource location within the first uplink subframe and transmitting the first uplink subframe to the base station.

Subsequently, step 2008 includes receiving a second downlink subframe from among the plurality of subsequent downlink subframes, where the second downlink subframe includes a second data signal. In an embodiment, the second downlink subframe does not include a control signal describing the second data signal and which can be used to derive an uplink resource location for sending an ACK/NACK response to the base station.

Process 2000 then proceeds to step 2010, which includes identifying a second control information search space associated with the second downlink subframe. As described above, a control information search space is associated with each downlink subframe transmitted to the UE. The control information search space identifies to the UE a set of CCEs within which a control signal describing the data signal contained in the downlink subframe can be found. Although the second downlink subframe does not actually include a control signal, the second control information search space can still be defined and identified by the UE.

Then, in step 2012, process 2000 includes determining, based on a start location of the second control information search space, a second resource location within a second uplink subframe for transmission from the UE to the base station. The second resource location is reserved for a second ACK/NACK response to the second data signal contained in the second downlink subframe. In an embodiment, the second resource location corresponds to a PUCCH resource element of the second uplink subframe.

In an embodiment, step 2012 includes determining an offset between the resource index determined in step 2004 and an index of a first CCE of a first control information search space associated with the first downlink subframe; determining an index of a first CCE of the second control information search space; and determining the second resource location based on a sum of the offset and the index of the first CCE of the second control information search space.

In another embodiment, instead of steps 2010 and 2012, process 2000 includes, after step 2008, determining the second resource location within the second uplink subframe based on the resource index determined in step 2004. As such, the second resource location used for sending the second ACK/NACK response to the base station in the second uplink subframe would have the same location index as the first resource location used for sending the first ACK/NACK response to the base station in the first uplink subframe.

In another embodiment, after step 2012, process 2000 may further include inserting the second ACK/NACK response at the second resource location within the second uplink subframe and transmitting the second uplink subframe to the base station.

For the purposes of this discussion, the term “processor circuitry” shall be understood to include one or more: circuit(s), processor(s), or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to embodiments described herein. Alternatively, the processor can access an internal or external memory to retrieve instructions stored in the memory, which when executed by the processor, perform the corresponding function(s) associated with the processor.

In this disclosure, terms defined by the Long-Term Evolution (LTE) standard are sometimes used. For example, the term “eNodeB” or “eNB” is used to refer to what is commonly described as a base station (BS) or a base transceiver station (BTS) in other standards. The term “User Equipment (UE)” is used to refer to what is commonly described as a mobile station (MS) or mobile terminal in other standards. However, as will be apparent to a person of skill in the art based on the teachings herein, embodiments are not limited to the LTE standard and can be applied to other wireless communication standards, including, without limitation, WCDMA, WLAN, and Bluetooth.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments as other embodiments will be apparent to a person of skill in the art based on the teachings herein.

What is claimed is:

1. A User Equipment (UE), comprising:
processor circuitry configured to:
receive a first downlink subframe from a base station, the first downlink subframe including a first data signal and a control signal, the control signal describing a plurality of subsequent consecutive downlink subframes scheduled for transmission from the base station to the UE;
determine a resource index associated with the control signal from the first downlink subframe;
determine, based on the resource index, a first resource location within a first uplink subframe for transmission from the UE to the base station, the first resource location reserved for a first acknowledgment/no-acknowledgment (ACK/NACK) response to the first data signal; and
insert the first ACK/NACK response at the first resource location within the first uplink subframe; and
transceiver circuitry configured to transmit the first uplink subframe to the base station.

2. The UE of claim 1, wherein the first downlink subframe and the plurality of subsequent downlink subframes are consecutive.

3. The UE of claim 1, wherein the resource index corresponds to an index of a first control channel element (CCE) of the control signal.

4. The UE of claim 1, wherein the control signal indicates a number of the plurality of subsequent downlink subframes.

5. The UE of claim 1, wherein the control signal includes, for at least one subframe of the plurality of subsequent downlink subframes, a starting data symbol index for identifying a starting data symbol within said at least one subframe.

6. The UE of claim 1, wherein the plurality of subsequent downlink subframes include data only.

7. The UE of claim 1, wherein the processor circuitry is further configured to:
receive a second downlink subframe from among the plurality of subsequent downlink subframes, the second downlink subframe including a second data signal; and
determine, based on the resource index, a second resource location within a second uplink subframe for transmission from the UE to the base station, the second resource location reserved for a second ACK/NACK response to the second data signal.

8. The UE of claim 1, wherein the processor circuitry is further configured to:
receive a second downlink subframe from among the plurality of subsequent downlink subframes, the second downlink subframe including a second data signal;
identify a control information search space associated with the second downlink subframe; and
determine, based on a start location of the control information search space, a second resource location within a second uplink subframe for transmission from the UE to the base station, the second resource location reserved for a second ACK/NACK response to the second data signal.

9. The UE of claim 1, wherein the processor is configured to:
determine an offset between the resource index and an index of a first control channel element (CCE) of a first control information search space associated with the first downlink subframe;
receive a second downlink subframe from among the plurality of subsequent downlink subframes, the second downlink subframe including a second data signal;
identify a second control information search space associated with the second downlink subframe;
determine an index of a first CCE of the second control information search space; and
determine the second resource location based on a sum of the offset and the index of the first CCE of the second control information search space.

10. A method performed by a User Equipment (UE), comprising:
receiving a first downlink subframe from a base station, the first downlink subframe including a first data signal and a control signal, the control signal describing a plurality of subsequent consecutive downlink subframes scheduled for transmission from the base station to the UE;
determining a resource index associated with the control signal from the first downlink subframe;
determining, based on the resource index, a first resource location within a first uplink subframe for transmission from the UE to the base station, the first resource location reserved for a first acknowledgment/no-acknowledgment (ACK/NACK) response to the first data signal;
inserting the first ACK/NACK response at the first resource location within the first uplink subframe; and
transmitting the first uplink subframe to the base station.

11. The method of claim 10, wherein the first downlink subframe and the plurality of subsequent downlink subframes are consecutive.

12. The method of claim 10, wherein the resource index corresponds to an index of a first control channel element (CCE) of the control signal.

13. The method of claim 10, wherein the control signal indicates a number of the plurality of subsequent downlink subframes.

14. The method of claim 10, wherein the control signal includes, for at least one subframe of the plurality of subsequent downlink subframes, a starting data symbol index for identifying a starting data symbol within said at least one subframe.

15. The method of claim 10, wherein the plurality of subsequent downlink subframes include data only.

16. The method of claim 10, further comprising:
receiving a second downlink subframe from among the plurality of subsequent downlink subframes, the second downlink subframe including a second data signal; and
determining, based on the resource index, a second resource location within a second uplink subframe for transmission from the UE to the base station, the second resource location reserved for a second ACK/NACK response to the second data signal.

17. The method of claim 10, further comprising:
receiving a second downlink subframe from among the plurality of subsequent downlink subframes, the second downlink subframe including a second data signal;
identifying a second control information search space associated with the second downlink subframe; and
determining, based on a start location of the second control information search space, a second resource location within a second uplink subframe for transmission from the UE to the base station, the second resource location reserved for a second ACK/NACK response to the second data signal.

18. The method of claim 17, further comprising:
determining an offset between the resource index and an index of a first control channel element (CCE) of a first control information search space associated with the first downlink subframe; and
determining an index of a first CCE of the second control information search space; and
determining the second resource location based on a sum of the offset and the index of the first CCE of the second control information search space.

19. A User Equipment (UE), comprising:
processor circuitry configured to:
receive a plurality of consecutive downlink subframes, wherein the plurality of consecutive downlink subframes comprises a first downlink subframe and a set of subsequent downlink subframes, wherein the first downlink subframe includes a first data signal and a control signal and the set of subsequent downlink subframes include respective data signals;
determine a first index associated with a first control channel element (CCE) associated with the first downlink subframe; and
determine, based on the first index, a resource location within an uplink subframe for transmission from the UE to the base station, the resource location reserved for an acknowledgment/no-acknowledgment (ACK/NACK) response to the first data signal and the respective data signals; and
transceiver circuitry configured to transmit the uplink subframe to the base station.

20. The UE of claim 19, wherein the processor circuitry is configured to:
determine an offset between the first index and a second index associated with a first CCE of a first control information search space associated with the first downlink subframe;
identify a control information search space associated with a last downlink subframe of the set of subsequent downlink subframes;
determine an second index associated with a first CCE of the control information search space;
determine the resource location based on a sum of the offset and the index of the first CCE of the control information search space.
